(19) United States
(12) Patent Application Publication
(10) Pub. No.: US 2026/0067845 A1
(43) Pub. Date: Mar. 5, 2026

(54) NETWORK FUNCTION DE-REGISTRATION AND RE-REGISTRATION

(71) Applicant: T-Mobile Innovations LLC, Overland Park, KS (US)

(72) Inventors: Anil Kumar MARIYANI, Ashburn, VA (US); Subramania KAUSHIK, Bellevue, WA (US); Kashyap Narendra PATEL, Olathe, KS (US)

(21) Appl. No.: 18/825,140

(22) Filed: Sep. 5, 2024

(51) Int. Cl. H04W 60/06

(52) U.S. Cl. CPC H04W 60/06

(57) ABSTRACT

Methods and systems provided herein provide for de-registration and re-registration of network functions. Methods provided herein identify isolated network functions and trigger a notification from the network repository function (NRF) to the service communication proxy (SCP) of the isolation. The SCP deletes the isolated NF from storage and sends no further traffic to the NF. Upon detection of restoration of the network function, the network function may be prompted by the NRF to re-register with the NRF.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

5G networks include a core network utilizing a service based architecture (SBA) with multiple network functions (NFs). NFs register with a network repository function (NRF) to make their functions available to network components. However, NFs can become unavailable for multiple reasons. For example, a cut fiber on a server or data center hosting the NF can cause the NF to become isolated. Additionally, network functions may be subject to Internet Protocol (IP) or transport related isolation. As a further option, hypertext transfer protocol 2(HTTP2) load balancers may fail.

When the NFs are isolated, for any of the reasons described above, or for any other reasons, those NFs are unable to communicate with the NRF to de-register.

When the isolated NFs fail to de-register, unnecessary network traffic is directed towards those NFs. In 5G Model-D deployments, the NRF keeps a service communication proxy (SCP) updated with active registered 5G NFs. Because the isolated NFs remain registered, the SCP continues to direct traffic to the isolated NFs. The traffic from the SCP to the isolated NFs causes 503-NetworkFunction unavailable errors. The 503 errors cause further errors impacting network efficiency. Accordingly, a solution is needed for eliminating traffic flow to isolated NFs in order to improve network efficiency.

### OVERVIEW

Exemplary embodiments provided herein include a method for de-registering network functions (NFs) in isolation in order to prevent unnecessary network traffic and improve performance. A method includes identifying a network function (NF) in isolation mode and triggering a notification from a network repository function (NRF) to a service communication proxy (SCP), the notification indicating that the NF is in isolation mode. Responsive to the notification, the SCP updates its cache to de-register the NF.

Embodiments disclosed herein further include a system. The system includes a memory storing data and instructions and at least one processor executing the stored instructions to perform operations. The operations include triggering a notification from a network repository function (NRF) to a service communication proxy (SCP) regarding a network function (NF) in isolation mode. The notification indicates to the SCP that the NF is in isolation mode. The operations further include updating an SCP cache to de-register the NF responsive to the notification at the SCP.

In a further embodiment, a non-transitory computer-readable medium stores instructions executed by a processor to perform multiple operations. The operations include triggering a notification from a network repository function (NRF) to a service communication proxy (SCP) regarding a network function (NF) in isolation mode. The notification indicates that the NF is in isolation mode. The operations further comprising updating an SCP cache to de-register the NF responsive to the notification at the SCP.

Further embodiments include NRFs, SCPs, and processing nodes performing the operations described above. Further methods are provided for re-registering de-registered network functions.

### BRIEF DESCRIPTION OF THE DRAWINGS

FIG. 1 depicts an exemplary environment for a network function de-registration and re-registration system in accordance with an embodiment.

FIG. 2 depicts a network function de-registration and re-registration system in accordance with an embodiment.

FIG. 3 depicts a network function de-registration and re-registration system operating within a core network in accordance with an embodiment.

FIG. 4 depicts an exemplary method for network function de-registration in accordance with an embodiment.

FIG. 5 depicts a further exemplary method for network function de-registration in accordance with an embodiment.

FIG. 6 depicts an exemplary method for network function de-registration and re-registration in accordance with an embodiment.

FIG. 7 depicts an additional exemplary method for network function de-registration in accordance with an embodiment.

FIG. 8 is a diagram illustrating operation of the network function de-registration system in accordance with an embodiment.

FIG. 9 is a diagram illustrating operation of the network function de-registration and re-registration in accordance with an embodiment.

### DETAILED DESCRIPTION

In embodiments disclosed herein, functionality for a network repository function (NRF) is enhanced with the ability to de-register network functions (NFs) in isolation. Further, the NRF is provided with functionality to detect restoration of de-registered NFs and prompt the de-registered NFs to initiate re-registration.

In scenarios described herein, NFs become isolated through one of multiple failure scenarios and are therefore unable to de-register with the NRF. Accordingly, NRF functionality is enhanced with the ability to put NFs into maintenance mode and de-register the impacted NFs with the service communication proxy (SCP), by sending a hypertext transfer protocol 2(HTTP2) de-register message towards the SCP over a service based interface (SBI). Upon receiving the request from NRF, the SCP updates its cache and stops sending traffic towards the impacted NF.

Further scenarios described herein leverage the periodic heartbeats sent by NFs toward the NRF. The NRF tracks the incoming heartbeats. In case of a sudden heartbeat drop of a registered NF, the NRF performs a periodic heartbeat back to the registered NF. When a heartbeat failure occurs, e.g., outgoing heartbeats from the NRF to the registered NF are not being received or the NRF is not receiving heartbeats from a registered NF, then the NRF has the ability to put the registered NF into maintenance mode. Further, the NRF initiates de-registration of the failed NF by sending a notification to the SCP to delete the failed NF from the SCP cache.

In further scenarios, the failed NF that has been de-registered is restored. In this instance, the NF may be unaware that it has been forcibly de-registered by the NRF. In order to provide services within the network, the NF must register back to NRF. Accordingly, NF re-registration with the NRF for forcibly de-registered NFs can be done after the forcibly de-registered NF becomes available in the network. Once the NF is restored and becomes available, the NRF will start receiving heartbeats from the NF. Because the NRF knows it de-registered the NF forcibly, the NRF sends a notify message to the NF to perform re-reregistration towards the NRF.

In further scenarios described herein, the NRF transmits heartbeats to the NFs using a configurable timer. For example, the timer triggers a heartbeat every thirty seconds, every sixty seconds, etc. in accordance with a configurable timer. After a configurable threshold number of consecutive heartbeat failure messages, which may, for example, be three consecutive failed heartbeat messages, the NRF marks the NF as isolated, sets the NF to maintenance mode, and transmits a de-registration message to the SCP.

Accordingly, embodiments described herein facilitate de-registration of an NF from the NRF based on the isolation mode of the NF. The de-registration reduces error messages and excess traffic thereby improving network performance and reducing customer impact.

In addition to the systems and methods described herein, non-transitory computer-readable mediums may store the operations for the instructions or methods. Further, processing nodes on the network may execute the instructions or methods. The processing node may include a processor included in the NRF, the SCP, and/or a processor included in any controller node in the wireless network.

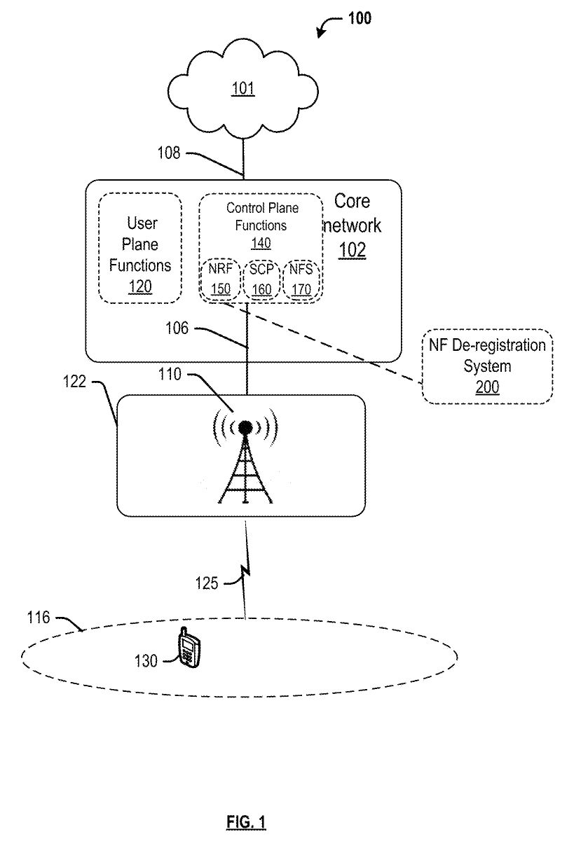

FIG. 1 depicts an exemplary environment 100 for implementing an NF de-registration and re-registration system 200. Environment 100 comprises a communication network 101, core network 102, and a radio access network (RAN) 122 including at least an access node 110. Wireless device 130 is located in a coverage area 116 and communicates with the access node 110 over communication link 125. Although only one wireless device 130 is shown, it should be understood that any number of wireless devices could be included. Further, the NF de-registration and re-registration system 200 interacts with the core network 102, which includes control plane functions 140 and user plane functions 120. Specifically, the NF de-registration and re-registration system 200 monitors NFs 170 and their registration status. Further, an NRF 150 interacts with an SCP 160 and multiple NFs 170 to perform de-registration and re-registration functions for the NFs 170 based on the status of the NFs 170 as being isolated and/or as being restored and returning to fully functional from isolation status.

The core network 102 includes an SBA architecture, in which service-based interfaces may be utilized between control plane functions 140, while multiple UPFs 120 connect over point-to-point link. The UPF 120 accesses a data network, such as network 101, and performs operations such as packet routing and forwarding, packet inspection, policy enforcement for the user plane, quality of service (QoS) handling, etc. The control plane functions 140 includes the NRF 150, SCP 160, and the multiple NFs 170, with each NF 170 authorized to access the services of other NFs 170.

The network repository function (NRF) 150 is a network function that maintains a record of available NFs 170 and their supported services. The NRF 150 allows other NFs 170 to subscribe and be notified of registrations from other NFs. The NRF 150 supports service discovery by receiving discovery requests from NFs 170 and providing details on which NFs 170 support specific services. Further, each NF 170 may subscribe to notifications from the NRF 150. As a result, each registered NF 170 can be notified of any changes to any other NF 170, such as when NFs 170 are added or removed. Each registered NF 170 can also interrogate the NRF 150 to discover other NFs 170 and the services they offer. Thus, the NRF 150 operates as a central registration center for other components of the core network 102.

The network functions (NFs) 170 may perform many varied functions, which are further described below. It should be understood that NFs 170 can include consumer NFs seeking a service from producer NFs. NFs 170 are self-contained, independent, and reusable. Each NF 170 exposes its functionality through a Service-Based Interface (SBI). The NFs 170 register their profiles to the NRF 150. The NFs 170 specify the services that are supported and query the NRF 150 to discover other NFs available for the service requested. Also, the NFs 170 may subscribe to the NRF 150 to be notified about status changes of other NFs 170.

The service communication proxy (SCP) 160 functions as an intermediary to enhance communication between different NFs 170. By facilitating service-based interactions, the SCP 160 optimizes discovery, routing, and load balancing of communications between network functions. The SCP 160 may be used to route messages between consumer and producer NFs 170 (also known as “indirect communications”), optimizing traffic routing with additional capabilities such as load-balancing and alternate routing. Thus, when a consumer NF 170 sends a request to the SCP 160, the SCP 160 routes the request to the target NF 170. The SCP 160 supports these indirect communications in accordance with the Third Generation Partnership (3GPP) Release-16 Model C and D. In Model C, the consumer NF communicates directly with the NRF 150 to discover the target producer NFs, and then uses the SCP 160 to route the requests. In Model D, the discovery of the target NF is offloaded to the SCP 160. In either case, the SCP 160 maintains a cache of registered NFs 170. The SCP cache may be periodically updated based on requests from the NRF 150.

The NF de-registration and re-registration system 200 is illustrated as communicating with or incorporated in the core network 102. In some embodiments, the NF de-registration and re-registration system 200 may be incorporated in or in direct communication with the NRF 150. The NF de-registration and re-registration system 200 may further communicate with or be partially incorporated in the SCP 160.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with a plurality of end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless device 130 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path - including combinations thereof. Communication link 106 can be wired or wireless and use various communication protocols such as Internet, Internet protocol (IP), local-area network (LAN), optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol as described herein. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

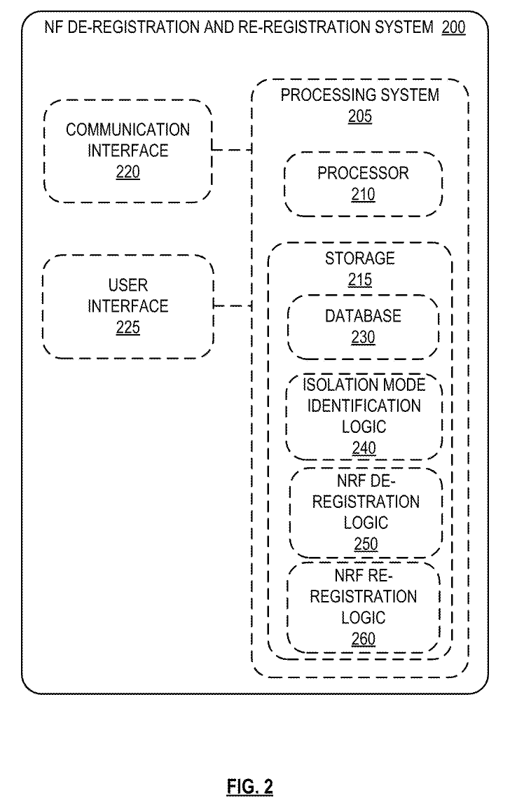

FIG. 2 illustrates an NF de-registration and re-registration system 200 in accordance with embodiments described herein. The components described herein are merely exemplary as many different configurations for the NF de-registration and re-registration system 200 may be implemented. The NF de-registration and re-registration system 200 may be configured to perform the methods and operations disclosed herein to dynamically de-register NFs 170 in isolation mode and further to re-register the de-registered NFs 170 once the de-registered NFs 170 are no longer isolated and are restored to regain functionality. In the disclosed embodiments, the NF de-registration and re-registration system 200 may be integrated with the core network 102, for example with the NRF 150, or may be an entirely separate component capable of communicating with at least the NRF 150 of the core network 102. Further, the components of the NF de-registration and re-registration system 200 may be distributed so that one or more components are located within the NRF 150, the SCP 160, the NFs 170, and/or a separate processing node in communication with or integrated with the core network 102.

The NF de-registration and re-registration system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, isolation mode identification logic 240 may be operable to identify NFs 170 that have become isolated due to one or more of the various factors described herein. NRF de-registration logic 250 may be utilized by and/or incorporated in the NRF 150 to ensure that isolated NFs 170 are properly de-registered and placed in maintenance mode. Further, NRF re-registration logic 260 may be operable to trigger re-registration of de-registered NFs 170 that are restored to become operational Further, the storage area 215 may include a database 230. The database 230 may store NF information, such as list of registered NFs 170 and their respective functions. To perform the above-described operations, the isolation mode identification logic 240, the NRF de-registration logic 250, and the NRF re-registration logic 260 may be executed by the processor 210 to manage de-registration and re-registration of NFs 170 and further to update the database 230.

Processor 210 may be a microprocessor and may include hardware circuitry and/or embedded codes configured to retrieve and execute software stored in storage device 215. The NF de-registration and re-registration system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the NF de-registration and re-registration system 200 and receive data or information from other system components. User interface 225 may include hardware components, such as touch screens, buttons, displays, speakers, etc. The NF de-registration and re-registration system 200 may further include other components such as a power management unit, a control interface unit, etc.

The location of the NF de-registration and re-registration system 200 may depend upon the network architecture. As set forth above, the NF de-registration and re-registration system 200 may be located in the core network 102, in a separate processing node, in the NRF 150, in multiple locations such as the NRF 150, SCP 160, and/or NF 170, or may be an entirely discrete component. Further, although shown as a single integrated system, the functions of NF de-registration and re-registration may be separated and be disposed in separate locations.

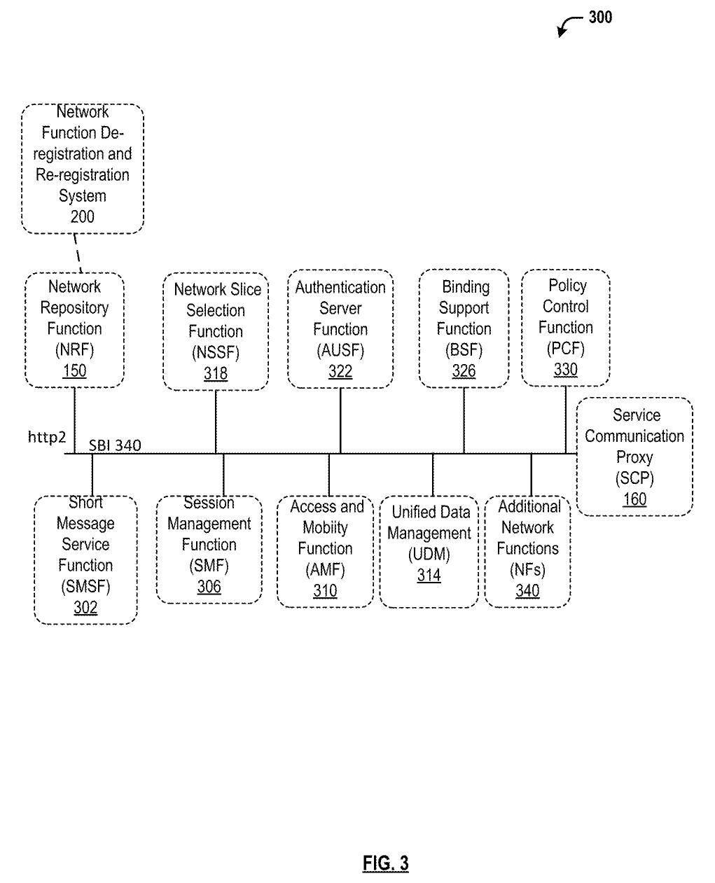

FIG. 3 depicts an environment 300 showing an NF de-registration and re-registration system 200 communicating with the NRF 150 within the core network 102 in accordance with an embodiment. Within the control plane 140 of the core network 102, multiple NFs 170 are capable of registering with the NRF 150. A short message service function (SMSF) 302, a session management function (SMF) 306, and an access and mobility function (AMF) 310 are illustrated. The SMF 306, AMF 310, and SMSF 302 are packet control functions, which interact with the RAN 122 and/or the user plane functions 120. Additional displayed functions are subscriber management functions such as a unified data management function (UDM) 314 and an authentication server function (AUSF) 322. Network resource functions may include, for example, a network slice selection function (NSSF) 318. A binding support function (BSF) 326 and a policy control function (PCF) 330 are also illustrated. However, it should be understood that a larger or smaller number of NFs 170 may be incorporated.

The SCP 160 operates as a routing agent between the NRF 150 and the NFs described above. More specifically, the SCP 160 may operate using http2 transaction messages over service based interfaces (SBIs) 340. Further, the SCP 160 incorporates a cache of registered NFs and manages the cache at the direction of the NRF 150.

As illustrated, the NF de-registration and re-registration system 200 may be incorporated in or communicate with the NRF 150. Further, the NF de-registration and re-registration system 200 may operate as a processing node in communication with the NRF 150 and SCP 160 in order to trigger these network functions to perform the operations described herein.

All of the illustrated network functions can include a processor, a memory, and may be configured to perform the various functions described herein. Further, each network function can associate with different reference points, including reference points for data transmission between different network nodes and reference points for control signal transmission between different network nodes.

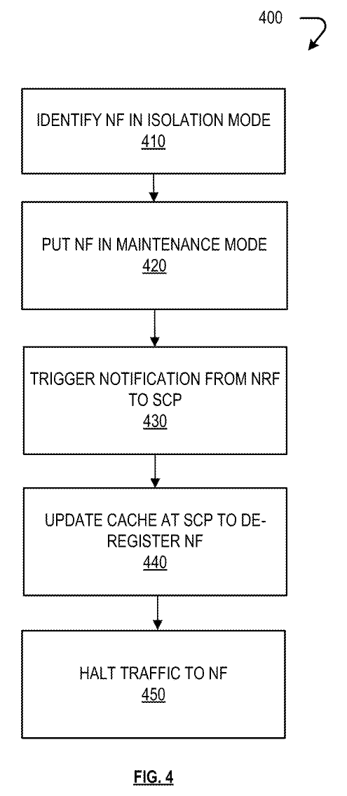

FIG. 4 illustrates a generalized exemplary method 400 for de-registering network functions in isolation using the NF de-registration and re-registration system 200. Method 400 may be performed by a processor, for example, the processor 210 included in the NF de-registration and re-registration system 200, or a processor in the NRF 150. For discussion purposes, as an example, method 400 is described as being performed by the processor 210 of the NF de-registration and re-registration system 200. However, it should be understood that the steps illustrated in FIG. 4 are performed in conjunction with the NRF 150 and the processor 210 may, in fact, be incorporated in the NRF 150.

Method 400 starts in step 410, in which the processor 210 identifies an NF in isolation mode. For example, a cut or damaged fiber on a server or data center hosting the NF or between the NRF 150 and a server associated with the NF can cause the NF to become isolated. Additionally, network functions may be subject to IP or transport related isolation. As a further option, hypertext transfer protocol 2(HTTP2) load balancers may fail or crash. In embodiments provided herein, the isolation identification logic 240 is executed by the processor 210 to identify isolated NFs. Isolated NFs may further be identified due to heartbeat failures as will be further described herein. Heartbeat refers to the transmission of a periodic signal by a first component to one or more other components to indicate normal operation of the first component and/or synchronization of the first component with the one or more other components. As another alternative, isolated NFs may be identified by a network operator or by another network component.

Upon identification of isolated NFs in step 420, the NRF 150 may put the isolated NF in maintenance mode so that trouble shooting can be performed. Maintenance mode is used to isolate an NF from the network in order to perform debugging or an upgrade or to locate and remediate the cause of isolation. Further, a notification is triggered from the NRF 150 to the SCP 160 in step 430. The notification message, may, for example, be an SBI http2 de-register message transmitted from the NRF 150 to the SCP 160. In order to de-register the isolated NF, the SCP 160, in response to the received message in step 430, updates the SCP cache to de-register the isolated NF in step 440. The effect of de-registering the isolated NF in step 430 is to halt traffic to the isolated NF in step 450. Thus, once the isolated NF is removed from the SCP cache, the SCP will no longer forward traffic to the isolated NF.

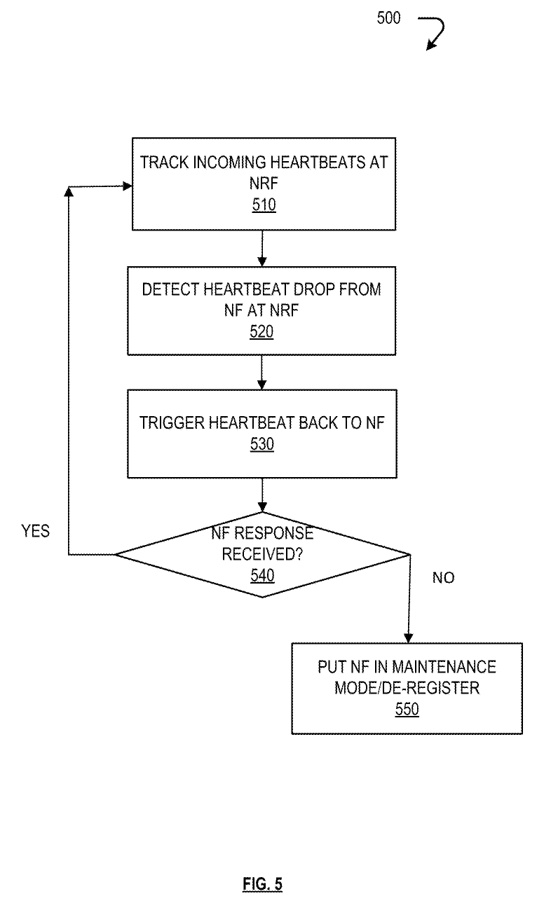

FIG. 5 depicts a further exemplary method 500 for de-registering an isolated NF in accordance with an embodiment. Method 500 may be performed by any suitable processor discussed herein, for example, the processor 210 included in the NF de-registration and re-registration system 200 or in the NRF 150. For discussion purposes, as an example, method 500 is described as being performed by the processor 210 included in the NF de-registration and re-registration system 200, which may be wholly or partially incorporated in the NRF 150.

Method 500 starts in step 510, in which the processor 210 tracks incoming heartbeats to the NRF 150 from registered NFs. The registered NFs send heartbeat messages periodically as an indicator of status to the NRF 150. The heartbeat message can be utilized to infer the health of the NFs. Thus, in step 520, the processor 210 may monitor for heartbeat drops at the NRF 150 and detect a heartbeat drop from an NF. Heartbeat drops may occur when heartbeat messages from an NF cease. Upon detecting a heartbeat drop from an NF in step 520, the processor 210 may trigger a heartbeat from the NRF 150 to the NF identified as having a heartbeat drop in step 530.

After triggering the heartbeat from the NRF 150 in step 530, the processor 210 may determine if a response from the NF is received in step 540. If a response is received in step 540, the processor 210 continues to track incoming heartbeats in step 510. However, if no response is received in step 540, the processor 210 may determine that the non-responsive NF is isolated. Accordingly, the processor 210 may trigger the NRF 150 to put the isolated NF in maintenance mode and de-register the isolated NF in step 550. In some embodiments, the NRF 150 may notify a network operator or another network function that the isolated NF should be put in maintenance mode. Maintenance mode is used to isolate an NF from the network in order to perform debugging or an upgrade or to locate and remediate the cause of isolation. When the system includes an SCP 160, this triggering may include causing the NRF 150 to send an http2 de-register message over the SBI 340 to the SCP 160.

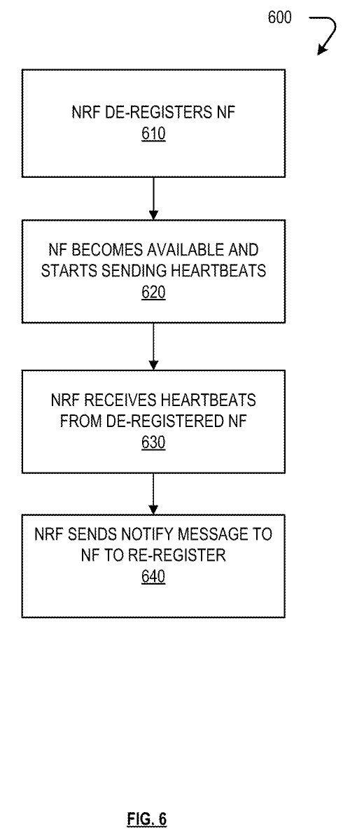

FIG. 6 depicts an additional exemplary method 600 for NF de-registration and re-registration in accordance with an embodiment. Method 600 may be performed by any suitable processor discussed herein, for example, the processor 210 in the NF de-registration and re-registration system 200, which may be wholly or partially incorporated in the NRF 150. For discussion purposes, as an example, method 600 is described as being performed by the processor 210 included in the NF de-registration and re-registration system 200.

In step 610, the processor 210 triggers the NRF 150 to de-register an isolated NF. The isolation may be detected by any of the methods described above. Further, as described above, once the isolated NF is de-registered, no additional traffic is directed to the isolated NF.

In step 620, the isolated NF once again becomes available and starts sending heartbeats towards the NRF 150. In step 630, the NRF 150 receives the heartbeats and the processor 210 detects the heartbeats from the de-registered NF. Upon detecting the heartbeats from the de-registered NF, the processor 210, in step 640, triggers a notification from the NRF 150 to the de-registered NF requesting the de-registered NF to re-register with the NRF 150. The re-registration process would occur in substantially the same manner as the original registration process between NFs and the NRF 150.

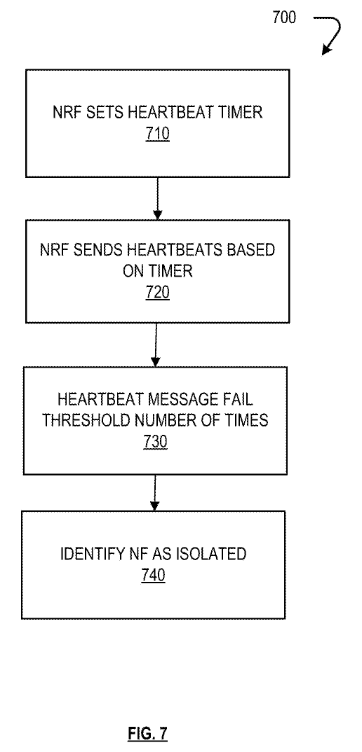

FIG. 7 depicts an additional exemplary method 700 for identifying an isolated NF in accordance with embodiments. Method 700 may be performed by any suitable processor discussed herein, for example, a processor 210 included in the NF de-registration and re-registration system 200, which may be wholly or partially incorporated in the NRF 150. For discussion purposes, as an example, method 700 is described as being performed by the processor 210.

In step 710, the processor 210 sets a heartbeat timer for the NRF 150. The heartbeat timer causes the NRF 150 to transmit periodic heartbeats to the NFs 170. In accordance with the parameters of the heartbeat timer, which may be included in the isolation identification logic 240, the processor 210 triggers periodic transmission of heartbeat messages from the NRF 150 to the NFs 170 in step 720. The periodicity is determined by the heartbeat timer.

Further in step 730, the processor 210 may detect heartbeat message failures for the outgoing heartbeat messages from the NRF and compare the number of failures to a pre-set threshold. For example, the pre-set threshold may be three failures, such that if the transmission of the heartbeat message from the NRF fails three times, the failures meet the pre-set threshold in step 730. Upon identifying that the number of failures meets the pre-set threshold in step 730, the processor 210 identifies the NF as isolated in step 750.

Accordingly, as set forth above, embodiments provide for NF de-registration upon isolation and re-registration upon restoration. In some embodiments, methods 400, 500, 600, and 700 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400, 500, 600, and 700 may be integrated in any useful manner.

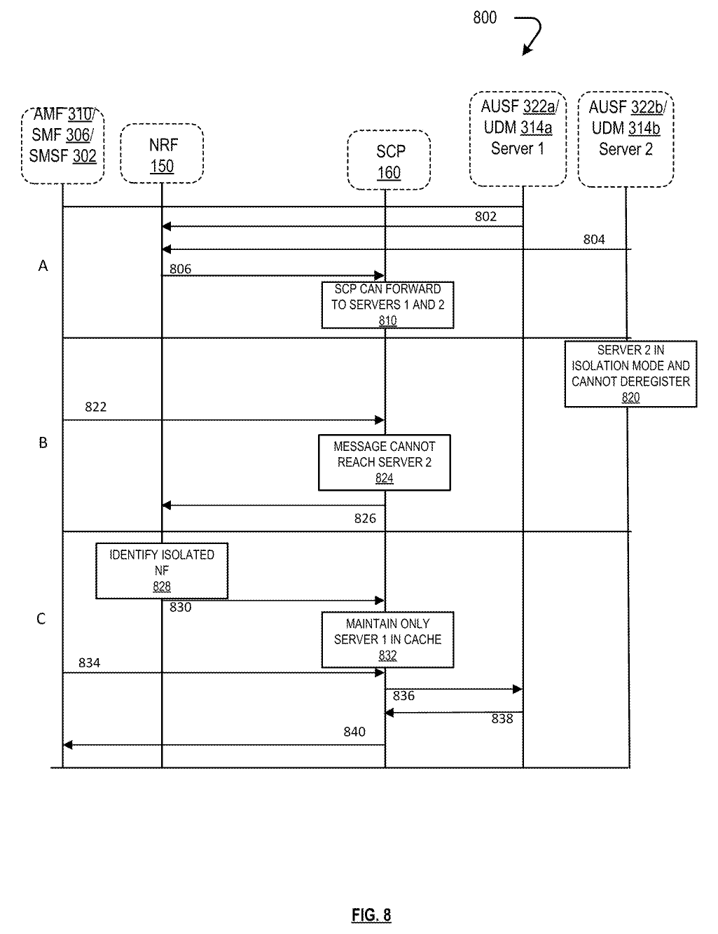

FIG. 8 is a diagram 800 illustrating operation of the NF de-registration and re-registration system 200 in accordance with an embodiment. As explained above, the NF de-registration and re-registration system 200 may be a discrete node operating in conjunction with the NRF 150, SCP 160 and/or NFs 170. The NF de-registration and re-registration system 200 may be partially or wholly incorporated in any of these components.

FIG. 8 illustrates interaction between the components of the core network 102 during de-registration of an isolated NF. Section A illustrates normal operation including registration of NFs with the NRF 150. As an example, NFs are shown as AUSF 322a and UDM 314a on Server 1 and AUSF 322b and UDM 314b on Server 2. In step 802, the AUSF 322a and UDM 314a on Server 1 register with the NRF 150. In step 804, the AUSF 322b and UDM 314b on Server 2 also register with the NRF 150. In step 806, the NRF 150 transmits an http2 message to the SCP 160 indicating that the NFs on server 1 and the NFs on server 2 have registered with the NRF 150. At this point, the SCP 160 is able to forward received messages to both servers 1 and 2 in step 810.

Section B illustrates a scenario that currently occurs when a NF becomes isolated in accordance with embodiments set forth herein. Initially, in step 820, server 2 becomes isolated, but with currently available implementations, server 2 is unable to de-register with the NRF. Accordingly, in step 822, when the SCP 160 receives an SBI http2 message from the AMF 310, SMF 306, or SMSF 302, while the SCP 160 may attempt to reach server 2, the message fails in step 824. Thus, in step 826, the SCP 160 sends a 503 NF failure message to the AMF 310, SMF, 306, or SMSF 302. In this scenario, excess messages cause network performance and the customer experience to deteriorate.

Section C illustrates a solution in accordance with embodiments set forth herein. In step 828, the NRF 150 receives a notification that server 2 is isolated. The notification made be made, for example, by a processor 210 detecting the 503 error or detecting the absence of heartbeats. Alternatively, the notification may be manually input by a network operator aware of the condition of server 2. In response, in step 830, the NRF 150 sends an http2 message to the SCP 160 indicating that server 2 is isolated and directs the SCP 160 to delete server 2 from the SCP cache. Accordingly, in step 832, the SCP 160 maintains only server 1 in the SCP cache as it has deleted server 2. Accordingly, upon receiving an SBI http2 message from the AMF 310, SMF 306, or SMSF 302 in step 834, the SCP 160 forwards the message to server 1 in step 836. In step 838, server 1 sends an acknowledgement (ACK) message to the SCP 160, which forwards the ACK message back to the AMF 310, SMF 306, or SMSF 302 in step 840. Accordingly, with this solution, the unnecessary steps of sending the message to server 2, which is in isolation, are eliminated.

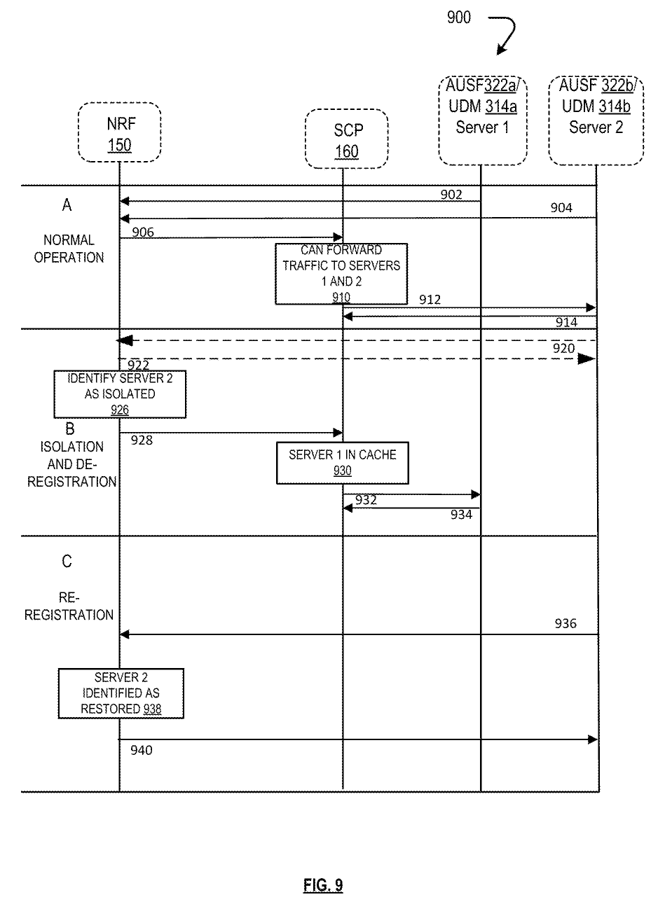

FIG. 9 illustrates a scenario 900 involving interaction between the components of the core network 102 in a further example when the NRF 150 monitors heartbeats between the NRF 150 and the NFs including AUSF 322a and UDM 314a on server 1 and AUSF 322b and UDM 314b on server 2. Section A illustrates the normal operation in this scenario. Specifically, server 1 registers with the NRF 150 in step 902 and server 2 registers with the NRF 150 in step 904. In step 906, the NRF 150 notifies the SCP 160 about registered NFs on servers 1 and 2 and in step 910, the SCP 160 is able to forward traffic to either server 1 or server 2. For example, in step 912, the SCP 160 forwards an SBI http2 message to server 2 and receives an acknowledgement (ACK) message from server 2 in step 914.

In contrast, Section B illustrates the scenario in which server 2 becomes isolated and solutions for de-registration proposed herein are implemented. Initially in step 920, server 2 attempts to send a heartbeat message to the NRF 150 and the message fails. Further, the NRF 150 attempts to send a heartbeat message to server 2 and the message fails in step 922. Further, the NRF 150 may send a predetermined threshold number of failed heartbeats towards the NFs in server 2 in step 922. Upon meeting this threshold, the processor 210 notifies the NRF 150 that server 2, and thus the NFs on server 2 are isolated in step 926. The NRF 150 may further put server 2 in maintenance mode in step 926. In step 928, the NRF 150 notifies the SCP 160 that server 2 is in isolation. Accordingly, in step 930, the SCP 160 deletes server 2 from the SCP cache and maintains server 1. Thus, in step 932, the SCP 160 is able to send SBI http2 messages to server 1 and receives an ACK message from server 1 in step 934.

Part C illustrates a scenario in which server 2 is restored in accordance with embodiments described herein. Initially, restoration of server 2 is apparent in step 936, when the NRF 150 receives a heartbeat message from server 2. This heartbeat message from server 2 indicates to the NRF 150 that server 2 and the NFs on server 2 including AUSF 322b and UDM 314b are restored in step 938. Accordingly, the processor 210 triggers a notification from the NRF 150 to the AUSF 322b and the UDM 314b to re-register with the NRF 150.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
identifying a network function (NF) in isolation mode;
triggering a notification from a network repository function (NRF) to a service communication proxy (SCP), the notification indicating that the NF is in isolation mode; and
responsive to the notification, updating an SCP cache to de-register the NF.

2. The method of claim 1, wherein the NF, NRF, and SCP operate within a 5G core network.

3. The method of claim 1, further comprising receiving, at the NRF, a heartbeat from the NF.

4. The method of claim 3, further comprising triggering a notification from the NRF to the NF requesting re-registration.

5. The method of claim 1, wherein identifying the NF in isolation mode includes identifying a damaged fiber between the NRF and a server associated with the NF.

6. The method of claim 1, wherein identifying the NF in isolation mode includes identifying crashed load balancers.

7. The method of claim 1, wherein identifying the NF in isolation mode includes identifying internet protocol (IP) or transport related isolation.

8. The method of claim 1, wherein triggering the notification comprises triggering a service based interface (SBI) hypertext transfer protocol 2 (HTTP2) de-register message towards the SCP.

9. The method of claim 1, further comprising halting traffic to the NF upon updating the SCP cache to de-register the NF.

10. The method of claim 1 wherein identifying the NF in isolation mode includes tracking incoming heartbeats from the NF and outgoing heartbeats from the NRF.

11. The method of claim 10, further comprising putting the NF into maintenance mode upon detecting a heartbeat failure.

12. The method of claim 10, further comprising receiving a heartbeat from an NF in isolation mode.

13. The method of claim 12, further comprising sending a notify message from the NRF to the NF upon receiving the heartbeat to perform re-registration towards the NRF.

14. A system comprising:
a memory storing data and instructions; and
at least one processor executing the stored instructions to perform operations including:
triggering a notification from a network repository function (NRF) to a service communication proxy (SCP) regarding a network function (NF) in isolation mode, the notification indicating that the NF is in isolation mode; and
responsive to the notification at the SCP, updating an SCP cache to de-register the NF.

15. The system of claim 14, wherein the operations further include halting traffic to the NF upon updating the SCP cache to de-register the NF.

16. The system of claim 14, wherein identifying the NF in isolation mode includes tracking incoming heartbeats from the NF and outgoing heartbeats from the NRF.

17. The system of claim 16, further comprising putting the NF into maintenance mode upon detecting a heartbeat failure.

18. A non-transitory computer-readable medium storing instructions executed by a processor to perform operations comprising:
triggering a notification from a network repository function (NRF) to a service communication proxy (SCP) regarding a network function (NF) in isolation mode, the notification indicating that the NF is in isolation mode; and
responsive to the notification at the SCP, updating an SCP cache to de-register the NF.

19. The non-transitory computer-readable medium of claim 18, the operations further tracking a received incoming heartbeat at the NRF from the NF.

20. The non-transitory computer-readable medium of claim 19, wherein the operations further comprise sending a notify message from the NRF to the NF upon receiving the incoming heartbeat to perform re-registration towards the NRF.
